(19) United States
(12) Patent Application Publication
(10) Pub. No.: US 2009/0213352 A1
(43) Pub. Date: Aug. 27, 2009

(54) METHOD FOR IMPROVING THE IMAGING PROPERTIES OF AN OPTICAL SYSTEM, AND SUCH AN OPTICAL SYSTEM

(75) Inventor: Aksel Goehnermeier, Essingen-Lauterburg (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/409,277

(22) Filed: Mar. 23, 2009

Related U.S. Application Data
(63) Continuation of application No. PCT/EP2007/008436, filed on Sep. 27, 2007.

(30) Foreign Application Priority Data
Oct. 2, 2006 (DE) 102006048310.3

(51) Int. Cl. G03B 27/52

(52) U.S. Cl. 355/67

(57) ABSTRACT

The disclosure relates to a method for improving the imaging properties of an optical system, such as a projection objective for microlithography. The disclosure also relates to an optical system, such as a projection objective for microlithography.

### CROSS-REFERENCE TO RELATED APPLICATIONS

This application is a continuation of, and claims benefit under 35 USC 120 to, international application PCT/EP2007/008436, filed Sep. 27, 2007, which claims benefit of German Application No. 10 2006 048 310.3, filed Oct. 2, 2006. International application PCT/EP2007/008436 is hereby incorporated by reference.

### FIELD

The disclosure relates to a method for improving the imaging properties of an optical system, such as a projection objective for microlithography. The disclosure also relates to an optical system, such as a projection objective for microlithography.

### BACKGROUND

In general, a projection objective is a part of a projection exposure machine that can be used in the production of semiconductor components. To this end, a pattern arranged in an object plane of the projection objective, which is denoted as a reticule, is imaged via the projection objective onto a photosensitive layer of a substrate which is denoted as a wafer. Aberrations which occur during the operation of the projection objective can be caused, for example, by heating of the projection objective by the imaging light. Such aberrations induced by heating can assume complicated field profiles, particularly when, as is the case with certain projection objectives, the beam path through the projection objective is not rotationally symmetrical with reference to the optical axis, and, in particular, individual optical elements are used by the beam path only in a subregion Age-induced aberrations can be caused, for example, by material changes in individual optical elements which are caused, for example, by a compaction of the material of the optical element.

### SUMMARY

In some embodiments, the disclosure provides a method and optical system having a comparatively simple structure.

In certain embodiments, at least one correction arrangement is arranged at least in the vicinity of a pupil plane of the optical system.

In some embodiments, one of the aspheric correction elements of the at least one correction arrangement is displaced by at least one manipulator in the direction of the optical axis. The procedure can enable, in particular, the correction of field-dependent aberrations, since the at least one correction arrangement is arranged in the vicinity of a pupil or in a pupil. By displacing at least one of the aspheric correction elements in the direction of the optical axis, it is possible to correct field-dependent aberrations, for example aberrations having a linear field profile. This is based on the fact that locations in the field of the optical system can correspond to angles in the pupil of the optical system. Beams which emanate from a field point on the optical axis can run through the optical correction arrangement in a fashion parallel, or substantially parallel, to the optical axis, and may not be influenced by a shift of the at least one correction element in the direction of the optical axis. Beams which, however, emanate from a field point outside the optical axis, traverse the correction arrangement in a fashion oblique to the optical axis such that these beams are generally influenced in the event of a shift of the at least one correction element in the direction of the optical axis, the degree of this optical action generally increasing for field points with increasing distance from the optical axis. This can result in a field dependence of the optical action of the correction arrangement during displacement of the at least one correction element in the direction of the optical axis.

In certain embodiments, aberrations of relatively high Zernike orders can be corrected dynamically during operation by, after appropriate measurement of an aberration, displacing the at least one correction element relative to the remaining correction element or correction elements in the direction of the optical axis until the measured aberration is completely or very largely corrected. Of course, it is also possible to provide a plurality of optical correction arrangements whose individual correction elements are provided with surface contours which differ from one another from correction arrangement to correction arrangement, in order to be able to correct various aberrations and also a superimposition of various aberrations.

In order to determine whether the correction arrangement in the protection objective is in the vicinity of a pupil plane, the paraxial subaperture ratio can be used.

The paraxial subaperture ratio S is given by

$$S = \frac{r}{\vert h \vert + \vert r \vert} sgn h$$

wherein r is the paraxial margin ray height, h the paraxial principal ray height and the function sgn x means the sign of x, wherein sgn 0=1 is defined. Principal ray height is understood as the ray height of the principal ray of a field point of the object field having maximum field height in absolute terms. Marginal ray height is the height of a ray of maximum aperture emanating from the middle of the object field.

The paraxial subaperture ratio is a magnitude which is a measure for the proximity of a plane in the beam path to a field or a pupil. By definition, the subaperture ratio is normalized to values between −1 and +1, wherein the subaperture ratio is zero in each field plane, and wherein the subaperture ratio has a discontinuity from −1 to +1 or from +1 to −1 in each pupil plane. As used herein, a subaperture ratio of 0 means a field plane, while an absolute value of the subaperture ratio of 1 determines a pupil plane. A plane which is located at least in the vicinity of the pupil plane of the optical system is a plane the absolute value of the subaperture ratio of which can be >0.7 (e.g., >0.8, >0.9, >0.95).

As far as reference is made to conjugate planes in the present application, this is to be understood that these planes have equal paraxial subaperture ratios.

It can, of course, also be provided to arrange at least one correction arrangement outside a pupil plane of the optical system, the field-dependent correction action decreasing with increasing distance of the correction arrangement from the pupil plane, and the field-constant correction action increasing.

In some embodiments, the at least one correction arrangement has two correction elements whose respective surface contours are provided on the mutually facing surfaces of the two correction elements. This can provide the advantage of a structurally simple design. When only two correction elements are provided, their surface contours are mutually complementary, and so they add together overall at least approximately to zero. It can be desirable to have the two correction elements are arranged immediately adjacent.

In some embodiments in which the two correction elements have a respective surface contour on the mutually facing surfaces, an advantage can be that, despite their aspheric surface contour, the two correction elements do not develop any kind of optical action in a position in which the two correction elements lie directly or almost directly against one another. Such a refinement of the correction arrangement therefore enables a zero position of the correction elements. Only after the detection of an aberration is at least one, or are both, correction elements displaced in the direction of the optical axis in order to increase the distance between the two correction elements so as to attain an optical action which compensates the recorded aberration.

In some embodiments, the at least one correction arrangement can have two correction elements whose respective surface contours are provided on the mutually opposite surfaces of the two correction elements. Here, as well, a structurally simple correction arrangement results, in turn, in which case, however, because of the arrangement of the aspheric surface contours on the mutually opposite surfaces no zero position of the two correction elements in relation to one another exists in which the correction arrangement does not develop an optical action when the correction arrangement is arranged in a pupil plane. However, this arrangement can be used to compensate a system immanent aberration, which is present, for example, after production of the optical system, and in the event of the occurrence of operationally induced aberrations for example owing to heating of individual optical elements of the system, the distance between the two correction elements is then correspondingly varied in order to obtain an additional optical action to compensate the detected aberration.

In some embodiments, the at least one correction arrangement has four correction elements of which two respectively have an identical first surface contour, and the other two respectively have an identical second surface contour which is complementary to the first surface contour, where the two correction elements with the second surface contour can be arranged between the two correction elements with the first surface contour. Such can provide the advantage that field profiles of aberrations can be compensated in two directions. In the case of the above described correction arrangement with two correction elements which have aspheric surface contours on their mutually facing surfaces, there is certainly a zero position in which the surface contours compensate one another with regard to their optical action against one another. However, this is often a position in which the two correction elements touch or almost touch one another. When the two correction elements are displaced apart from one another, an optical correction action results which is always of the same sign. In the case of the present refinement, by contrast, two pairs of correction elements are present, and in them the sequence of the surface contours is exactly reversed from the first pair to the second pair. There is thus a zero position of the correction arrangement in which no optical action is present, but in which the individual correction elements are located at a distance from one another, and the desired correction action can then be set by differently reducing or increasing the separations of the individual correction elements from pair to pair. Moreover, the optical correction action can be set in both directions through the zero position, and this may not be possible with a two-component correction arrangement.

The two inner correction elements can, for example, be stationary, that is to say fixedly installed, while at least one of the two outer correction elements can be assigned a manipulator for movement in the direction of the optical axis.

In some embodiments, the at least one correction arrangement has three correction elements of which two respectively have an identical first surface contour, and the third has a second surface contour which is at least approximately complementary to the sum of the first surface contour of the two other correction elements, and the third correction element is arranged between the two correction elements with the first surface contour. The two intermediate correction elements can be combined to form a single correction element, where the amplitude of the surface contour of the intermediate correction element is twice as large as the individual amplitudes of the surface contours of the two outer correction elements. By contrast with a four-component correction arrangement, the advantage of this refinement can involve in a structurally lower outlay, in particular, because only three optical correction elements need be provided with a surface contour.

In some embodiments, one of the correction elements with the first surface contour is connected to the intermediate third correction element in a fashion spaced apart therefrom. This can provide the advantage of enabling a bidirectional correction of aberrations, only two correction elements being involved overall to this end in this refinement.

It is possible in this case for one of the correction elements having the first surface contour to be fabricated in one piece with the intermediate third correction element.

Embodiments may involve only one manipulator, which is, for example, assigned to the correction element having the first surface contour.

In some embodiments, at least one of the surface contours is proportional to the function ∫ Zₙ(x,y), Zₙ(x,y) being an nth order Zernike coefficient.

It is known that aberrations can be classified in a series expansion using Zernike coefficients. An aberration of order Zₙ can be corrected most accurately when the aspheric surface contour is brought into a relationship with Zₙ. However, the optical correction action of the correction arrangement is not directly proportional to the function Zₙ(x,y), but to the integrated function ∫Zₙ. The reason for this is that when a beam traverses the correction arrangement obliquely the optical action corresponds to the gradient of the surface contours. Embodiments disclosed herein enable the detected Zₙ order aberration to be specifically corrected by an appropriate configuration of the aspheric surface contour.

Methods disclosed herein can be carried out such that the at least one correction element is displaced from a first position, in which the optical actions of the individual surface contours cancel out one another, into a second position, in which the desired correction action is achieved.

In some embodiments, there is provided for the at least one correction arrangement a replacement correction arrangement, or such a one is held ready, which has a plurality of replacement correction elements which are provided with aspheric surface contours which add together overall at least approximately to zero, but differ individually from the surface contours of the at least one correction arrangement. The at least one correction arrangement is replaced by the replacement correction arrangement in order to set a desired corrective action of the replacement correction arrangement by displacing at least one of the replacement correction elements relative to at least one of the remaining optical replacement correction elements, at least with a directional component in the direction of the optical axis.

It is advantageous here that, given appropriate design of the replacement correction arrangement, it is possible after replacement of the previously used correction arrangement to correct another aberration, which first appears, for example, during operation of the optical system. By keeping ready an appropriate number of different replacement correction arrangements it is then possible during operation of the optical system to react specifically to changes in the optical properties of the optical system, for example by respectively designing the replacement correction arrangements for specific aberrations which will probably occur in a specific operating mode of the optical system on the basis of corresponding predictions.

In some embodiments, the optical system has at least one second correction arrangement which has a plurality of second optical correction elements which, at least locally, define an optical axis and are provided with aspheric surface contours which add together overall at least approximately to zero but which differ individually from the surface contours of the at least one correction arrangement, at least one of the second correction elements being assigned at least one second manipulator for displacing this correction element relative to at least one of the remaining second correction elements at least with a directional component in the direction of the optical axis.

In some embodiments, the at least one of the second correction elements is displaced relative to at least one of the remaining second correction elements at least with a directional component in the direction of the optical axis, in order to set a desired correction action of the second correction arrangement. This can provide the advantage that a number of aberrations can be corrected simultaneously in the optical system, in particular independently of one another. Moreover, it is possible through the provision of at least two correction arrangements to use a superimposition of the corrective actions in order to correct aberrations which can be represented as a superimposition of two elementary aberrations. This can also raise the corrective potential of the optical system.

The at least second correction arrangement, or yet a further correction arrangement is advantageously arranged in or in the vicinity of a field plane of the optical system in order to be able to correct field-constant aberrations in addition to field-dependent aberrations.

In some embodiments, at least one of the correction elements is assigned a manipulator for displacing the correction element additionally or exclusively with a directional component in a direction transverse to the optical axis. Given the corresponding refinement of the method, at least one of the correction elements is additionally or exclusively displaced with a directional component in the direction transverse to the optical axis. This measure has the advantage that superimposing a shift at least of one correction element or the shift of a correction element in the direction of the optical axis and another correction element in the direction transverse to the optical axis renders it possible for the displacement path in the direction of the optical axis to be kept smaller for the purpose of attaining the same optical action, and this is sometimes advantageous for reasons of space inside the optical system.

In some embodiments, the correction elements are arranged in mutually optically conjugate planes of the optical system.

It is advantageous here that the actions of the individual correction elements on the image are at least approximately identical. For example, a first correction element can be arranged in a first pupil plane, and a second correction element can be arranged in a second pupil plane of the optical system.

Further advantages and features emerge from the following description and the attached drawing.

Features mentioned above and those still to be explained below can be used not only in the respectively specified combination, but also in other combinations or on their own without departing from the framework of the present disclosure.

### BRIEF DESCRIPTION OF THE DRAWINGS

Exemplary embodiments of the disclosure are illustrated in the drawing and will be described in more detail hereafter with reference thereto. In the drawing:

FIG. 1 shows a diagrammatic illustration of an optical system on the example of a projection objective of a projection exposure machine for microlithography;

FIG. 2 shows a diagrammatic illustration of the beam path in an optical system in or in the vicinity of a pupil plane;

FIG. 3 shows an illustration of a principle of a correction arrangement in or in the vicinity of a pupil plane of the optical system in FIG. 1;

FIG. 4 shows an individual correction element of the correction arrangement in FIG. 3 for correcting a Z₁₀ order aberration;

FIG. 5 shows a correction arrangement, which can be used in the optical system in FIG. 1;

FIG. 6 shows a correction arrangement, which can be used in the optical system in FIG. 1;

FIG. 7 shows a correction arrangement which can be used in the optical system in FIG. 1; and

FIG. 8 shows an illustration of the principle of a correction arrangement which is arranged in or in the vicinity of a field plane.

### DETAILED DESCRIPTION

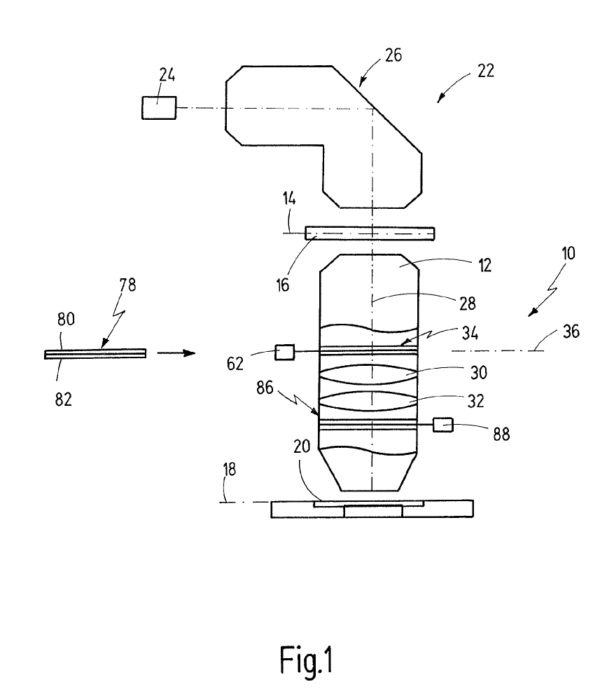

An optical system provided with the general reference numeral 10 is illustrated in FIG. 1 in the form of a projection objective 12 which is used in microlithography in order to produce microstructured components. The projection objective 12 serves for imaging a reticule 16, which is arranged in an object plane 14 and has a pattern, onto a substrate 20 (wafer) arranged in an image plane 18. The projection objective 12 is part of a projection exposure machine 22 which, apart from the projection objective 12, includes a light source 24, usually a laser, and an illuminating system 26.

In order to simplify the description, and without restricting generality, it is assumed in the case of the following description of the optical system 10 in the form of the projection objective 12 that the projection objective 12 has only one optical axis 28.

The projection objective 12 has a plurality of optical elements of which, by way of example, two optical elements 30 and 32 are shown in FIG. 1 in the form of lenses. However, it goes without saying that apart from the two optical elements 30 and 32 the projective objective 12 has further optical elements in the form of lenses and/or mirrors.

It is generally desirable for the projection objective 12 that the pattern of the reticule 16 is imaged onto the substrate 20 as far as possible without aberrations. Even when the projection objective 12 can be produced in terms of fabrication technology such that it shows no immanent aberrations before commissioning, it is possible during operation of the projection objective 12 for there to appear aberrations which worsen the structural accuracy of the imaging of the pattern of the reticule 16 onto the substrate 20. One cause of such aberrations occurring in operation may, in particular, be heating of the individual optical elements 30, 32 which can lead to changes in the surface geometry of these elements, a change in material properties, in particular the refractive indexes of these elements, etc. In particular, such aberrations caused by heating can lack rotational symmetry with the optical axis 28, particularly when the illumination of the projection objective 12 via the illuminating system 26 is not rotationally symmetrical. For example, in the case of a dipole or quadrupole illumination in which the imaging light which traverses the projection objective 12 is split into a number of individual, mutually separated beams, or in the case of an off-axis traversal of light through the projection objective 12, as is the case, in particular, with catadioptric projection objectives which are constructed from lenses and mirrors, it is possible for heat-induced aberrations to occur which are not rotationally symmetrical.

In order to be able during operation to react dynamically in a short time to such aberrations which appear, the projection objective 12 has at least one correction arrangement 34, which is described in more detail below.

The correction arrangement 34 is arranged in a pupil plane 36 of the projection objective 12, or is located at least in the vicinity of this pupil plane 36.

In order to determine whether the correction arrangement in the protection objective is in the vicinity of a pupil plane, the paraxial subaperture ratio can be used.

The paraxial subaperture ratio S is given by

$$S = \frac{r}{\vert h \vert + \vert r \vert} sgn h$$

wherein r is the paraxial margin ray height, h the paraxial principal ray height and the function sgn x means the sign of x, wherein sgn 0=1 is defined Principal ray height is understood as the ray height of the principal ray of a field point of the object field having maximum field height in absolute terms. Marginal ray height is the height of a ray of maximum aperture emanating from the middle of the object field.

The paraxial subaperture ratio is a magnitude which is a measure for the proximity of a plane in the beam path to a field or a pupil. By definition, the subaperture ratio is normalized to values between −1 and +1, wherein the subaperture ratio is zero in each field plane, and wherein the subaperture ratio has a discontinuity from −1 to +1 or from +1 to −1 in each pupil plane. As referred to herein, a subaperture ratio of 0 means a field plane, while an absolute value of the subaperture ratio of 1 determines a pupil plane. A plane which is located at least in the vicinity of the pupil plane of the optical system is a plane the absolute value of the subaperture ratio of which can be >0.7 (e.g., >0.8, >0.9, >0.95).

As far as reference is made to conjugate planes in the present application, this is to be understood that these planes have equal paraxial subaperture ratios.

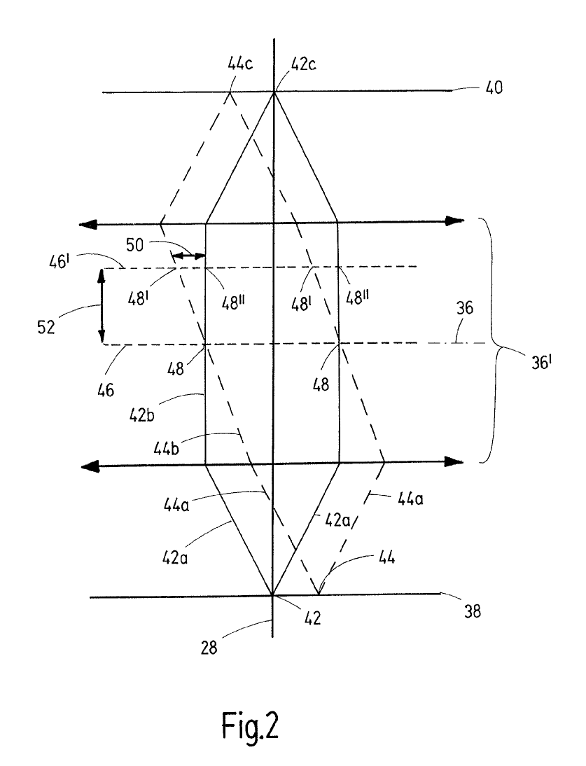

Before going in more detail into the configuration of the correction arrangement 36, the beam profile of the imaging light in the region of the pupil plane 36 is firstly explained with reference to FIG. 2.

To aid comprehension, a pupil region 36′ is illustrated in FIG. 2 in a spread out fashion. Also shown in FIG. 2 are a field plane 38 and a field plane 40, the field plane 38 possibly being the image plane 18, and the field plane 40 the object plane 14. However, the field planes 38 and 40 can also be intermediate image planes of the projection objective 12.

Observing a field point 42 on the optical axis 28 and the light beams 43a emanating from the axial field point 42, these light beams traverse the pupil region 36′ in parallel (lines 42b) and, downstream of the pupil region 36′, run together at an axial field point 42c of the field plane 40.

By contrast, light beams 44a emanating from an off-axis field point 44 traverse the pupil region 36′ obliquely in relation to the optical axis 28 (lines 44b) and run together again at an off-axis field point 44c in the field plane 40.

It follows from this that beams of different field points 42, 44 have different angles to the optical axis in the pupil plane 36. This angle increases with increasing distance of a field point from the optical axis 28.

If an optical element 46, for example a plate, is now arranged directly in the pupil plane 36, the points of traverse 48 of the light beams 42b and 44b which emanate from the axial field point 42 and the off-axis field point 44, respectively, are identical. If the optical element 46 is displaced in the direction of the optical axis 28 from the pupil plane 36 into a position 46′, the points of traverse 48′ of the light beams 44b are mutually offset by comparison with the points of traverse 48″ of the light beams 42b transverse to the optical axis 28, as is indicated in FIG. 2 by a double arrow 50. Thus, a specific offset 50 of the points of traverse 48′ and 48″ corresponds to a specific displacement path 52 of the optical element 46 in the direction of the optical axis. In other words, after a displacement path 52 of the optical element 46 the light beams 44b see another optically active region of the optical element 46 than the light beams 42b. It is now possible to attain an optical action dependent on the displacement path 52 by designing the optical element 46, for example by means of aspherization, with a specific surface contour.

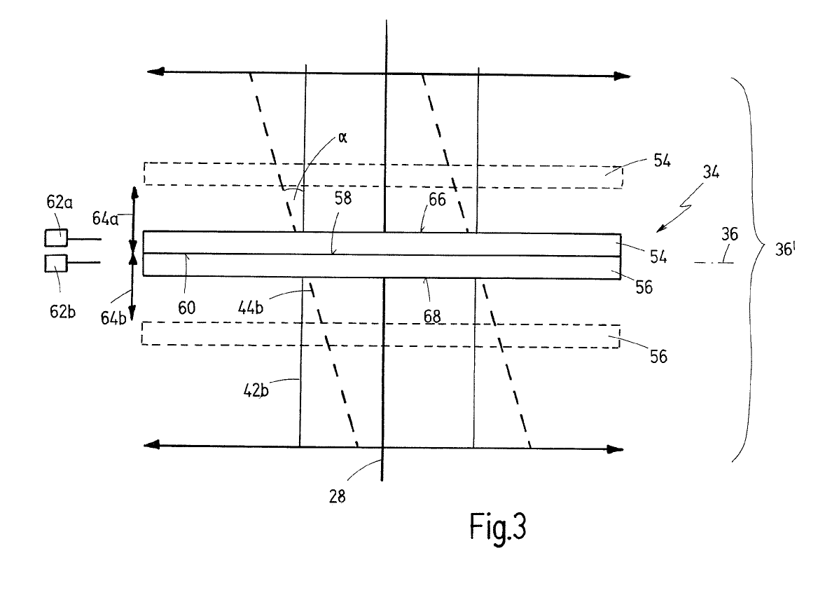

The above described effect is now used in the correction arrangement 34 in FIG. 1 as described below with reference to FIG. 3.

In accordance with FIG. 3, the optical correction arrangement 34 has a first optical correction element 54 and a second optical correction element 56. The optical correction element 54 is provided with an aspheric surface contour, specifically on its surface 58 facing the correction element 56, and the second correction element 56 is provided with its surface 60 facing the correction element 54 with an aspheric surface contour which is complementary to the surface contour of the correction element 54. The sum of the surface contours is therefore zero.

Except for their aspheric surface contours, the correction elements 54 and 56 are desirably designed as plane-parallel plates. The correction elements 54 and 56 are arranged immediately adjacent to one another. If, as illustrated by unbroken lines in FIG. 3, the correction elements 54 and 56 are arranged such that the mutually facing surfaces 58 and 60 touch or almost touch, the correction arrangement 34 has the overall form of a plane-parallel plate and has no optical action (except for a beam offset).

If, as illustrated by broken lines in FIG. 3, the correction elements 54 and 56 are now displaced in the direction of the optical axis such that they are spaced apart from one another, because of the aspherization of the surfaces 58 and 60 there appears in accordance with the previous description with reference to FIG. 2 an optical action with the aid of which it is possible in accordance with the contour of the aspherization of the surfaces 58 and 60 to correct a specific aberration, and in particular an aberration with a linear field profile.

In accordance with FIG. 1, at least one manipulator 62 is assigned for displacing at least one of the optical correction elements 54 and/or 56 in the direction of the optical axis 28. In FIG. 3, the two correction elements 54 and 56 are respectively assigned a manipulator 62a and 62b such that the two correction elements 54 and 56 can be displaced in accordance with double arrows 64a and 64b in the direction of the optical axis 28 in order to set a desired corrective action of the correction arrangement 34.

In the starting position, in which the correction elements 54 and 56 lie against one another or lie almost against one another, the correction arrangement 34 is desirably located directly in the pupil plane 36.

The aspheric surface contours of the optical correction elements 54 and 56 are selected to be proportional to the function ∫Zₙ(x,y), Zₙ(x,y) being an nth order Zernike coefficient.

When the aspheric surface contour is proportional to the integral of an aberration, the optical action of this aspheric surface contour corresponds in the case of a displacement of the optical correction elements 54 and 56 relative to one another precisely to the aberration to be corrected, since the optical action of the surface contour is proportional to the gradient of the surface contour.

The calculation of the aspheric surface contour is described below on the example of a correction of a Z₁₀ order aberration.

In polar coordinates (r, Φ),

Z₁₀=r³ cos(3Φ).

Converting Z₁₀ into Cartesian coordinates yields:

Z₁₀=x³−3y²x

The abovementioned function is integrated in terms of x in order to calculate the aspheric surface contour O(x,y) of the correction elements 54 and 56:

$$O ( x , y ) \approx \int ( {x}^{3} - 3 {y}^{2} x ) d x \\ = 1 / 4 {x}^{4} - \frac{3}{2} {y}^{2} {x}^{2}$$

The surface function O(x,y) is now applied once as O(x,y) to the surface 58 of the correction element 54, and once as —O(x,y) to the surface 60 of the correction element 56, or vice versa.

If the two surfaces 58 and 60 are arranged directly or almost directly lying one on the other, as is illustrated in FIG. 3 with continuous lines of the correction elements 54 and 56, no corrective action by the correction arrangement 34 results. If, however, the correction elements 54 and 56 are displaced relative to one another in the direction of the optical axis 28, an optical corrective action results as previously described.

Described below as an example is the case in which the aim is to correct a wave front aberration with an amplitude of approximately 10 nm of the aberration in Z₁₀ at the field edge in order to correct an aberration based on heating of individual optical elements. A diameter of approximately 100 mm in the pupil plane 36 of the projection objective 12 is assumed for the correction elements 54 and 56, and the displacement paths corresponding to the arrows 64a and 64b are intended to lie at approximately 100 μm in the direction of the optical axis 28. Moreover, a maximum angle α (compare FIG. 3) of approximately 25° is assumed in the pupil plane.

Assuming the above-mentioned parameters, the amplitude of the aspheric surface contour O(x,y) can be calculated as follows:

The function O(x,y) is firstly normalized to the pupil radius R:

$$O ( x , y ) ∝ \frac{1}{{R}^{4}} ( 1 / 4 {x}^{4} - \frac{3}{2} {y}^{2} {x}^{2} ) .$$

Subsequently, an amplitude A₀ of the aspheric surface contour is introduced:

$$O ( x , y ) = \frac{{A}_{0}}{{R}^{4}} ( 1 / 4 {x}^{4} - \frac{3}{2} {y}^{2} {x}^{2} ) .$$

A displacement of the optical correction elements 54 and 56 by the amount yields as optical action

$$Zn = Δ n ( \begin{matrix}O ( x + Δ , y ) - \\ O ( x - Δ , y )\end{matrix} ) = Δ n \frac{{A}_{0}}{{R}^{4}} ( 2 Δ ( {x}^{3} - 3 {y}^{2} x ) + 2 {Δ}^{3} x ) ,$$

Δn denoting the difference in refractive index between air and glass.

The following calculation then results for the surface amplitude A₀:

$$Δ n \frac{{A}_{0}}{{D}^{4}} ( 2 Δ ( {x}^{3} - 3 {y}^{2} x ) ) {=}^{!} 10 nm$$

$$for$$

$$Δ = \frac{sin α}{\sqrt{1 - {sin}^{2} α}} {D}_{M } \approx 44 µm$$

D_{M} is the total displacement path of 100 μm in the Z-direction.

$$x = R \hat{} y = 0$$

$$R = 50 mm$$

$$Δ n = 0.5$$

$$\begin{matrix}{A}_{0} = \frac{10 nm \cdot {R}^{4}}{Δ n \cdot 2 Δ ( {x}^{3} - 3 {y}^{2} x )} \\ = \frac{10 nm \cdot R}{Δ n \cdot 2 Δ} \\ = \frac{10 nm \cdot 50 mm}{0.5 \cdot 88 µm} \approx 11 µm .\end{matrix}$$

A maximum ablation height Aₘₐₓ of

$${A}_{MAX } = Max ( O ) - Min ( O ) = \frac{9}{16} {A}_{0} \approx 6.4 µm$$

is yielded therefrom.

Thus, the result for the selected parameters is an aspheric surface contour having an ablation shape with an amplitude of 6.4 μm.

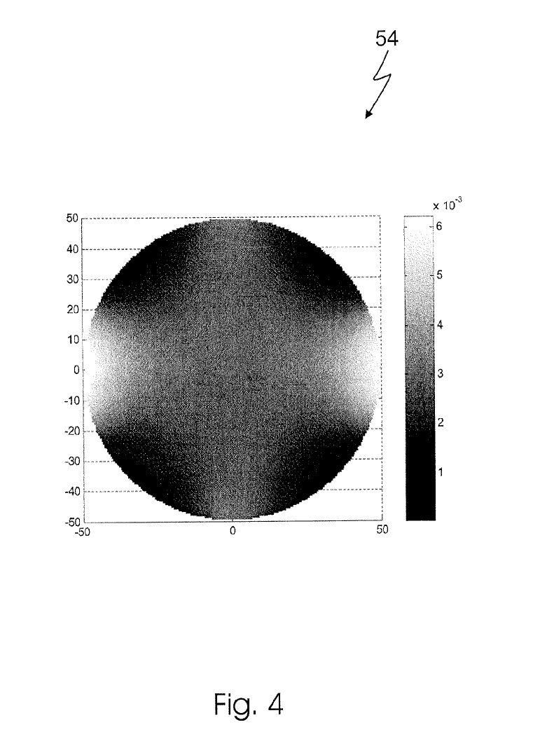

FIG. 4 illustrates for the correction element 54 the aspheric surface contour that results for Z₁₀ with the above-mentioned parameters. The different ablation heights or ablation amplitudes are illustrated by various levels of grey, the ablation height or ablation amplitude increasing with increasing dark values.

The aspheric surface contours thus determined are applied to the correction element 54 and to the correction element 56 with opposite signs.

When the correction elements 54 and 56 are arranged immediately adjacent, as illustrated in FIG. 3 by continuous lines, the result is then no optical corrective action by the correction arrangement 64. From this position, the correction elements 54 and 56 are then displaced relative to one another according to the arrows 64a and 64b in the direction of the optical axis 28, in order to set the desired corrective action. As already described, this total displacement path is approximately 100 μm given the above-mentioned parameters.

Whereas it was previously described that the aspheric surface contours are provided on the mutually facing surfaces 58 and 60 of the correction elements 54 and 56, the aspheric surface contours can also be provided on the mutually opposite surfaces 66 and 68 of the correction elements 54 and 56. However, in this case no zero position of the correction arrangement 34 results, even when the latter is arranged in the pupil plane 36, although the individual aspheric surface contours add together overall to zero. This is owing to the fact that the correction elements 54 and 56 are of finite thickness, and so the mutually opposite surfaces 66 and 68 are traversed by the light beams 44b at different points.

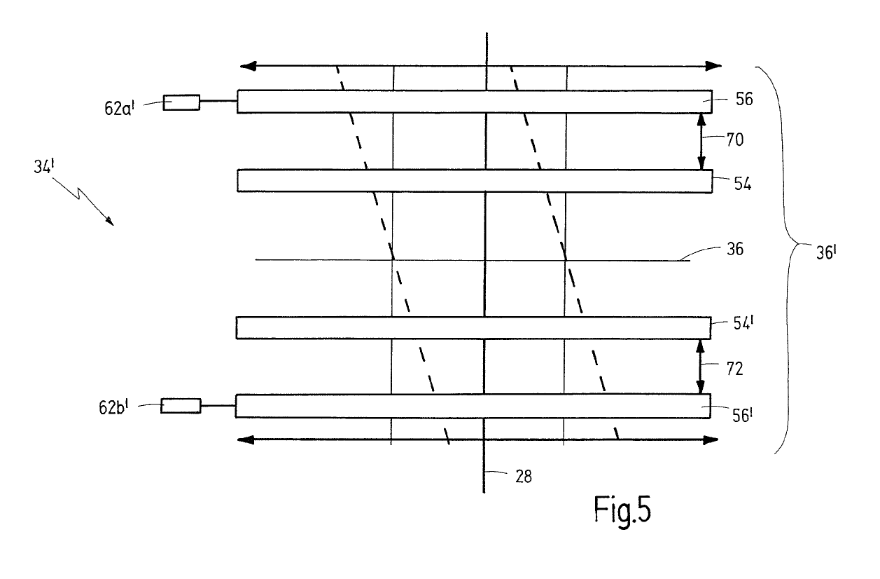

A refinement of a correction arrangement 34′ which is modified by comparison with FIG. 3 and is formed overall from four correction elements 54, 56; 54′, 56′ is described below with reference to FIG. 5.

Whereas in the case of the correction arrangement 34 in FIG. 3 the correction elements 34 and 56 desirably almost or completely touch in the zero position so that the correction arrangement 34 does not develop an optical corrective action, and, moreover, only aberrations having a field profile with one direction can be compensated by the correction arrangement 34, these properties are eliminated in the case of the correction arrangement 34′.

In addition to the two correction elements 54 and 56, which can be configured as in FIG. 3, the correction arrangement 34′ has a further pair of correction elements 54′ and 56′, the aspheric surface contours of the correction element 54′ being at least almost identical to the aspheric surface contour of the correction element 54, and the aspheric surface contour 56′ being at least almost identical to the aspheric surface contour of the correction element 56.

The sequence of the optical correction elements 54′ and 56′, and thus the associated surface contours, however, is precisely the reverse of the sequence of the optical correction elements 54 and 56.

Owing to the reversed sequence of the mutually complementary surface contours in the pair of correction elements 54 and 56 relative to the sequence in the pair of correction elements 54′ and 56′, the zero position of this correction arrangement 34′, in which the latter has no optical corrective action, is as illustrated in FIG. 5, that is to say all the correction elements 54, 56, 54′, 56′ have a greater separation from one another than in the correction arrangement 34. Owing to the fact that a separation 70 between the correction elements 54 and 56 of the first pair is set by displacing at least one of the optical correction elements 54, 56, 54′, 56′ in the direction of the optical axis 28 otherwise than a separation 72 between the correction elements 54′ and 56′ of the second pair, it is possible to set a desired optical corrective action of the correction arrangement 34′ according to the previous description. For example, the correction element 56 and the correction element 56′, that is to say the two outer correction elements, can respectively be assigned a manipulator 62a′ and 62b′. By appropriately varying the separation 70 relative to the separation 72, it is now possible to correct aberrations with field profiles in two directions (+/−), it being possible to observe a greater separation between the individual correction elements 54, 56, 54′, 56′.

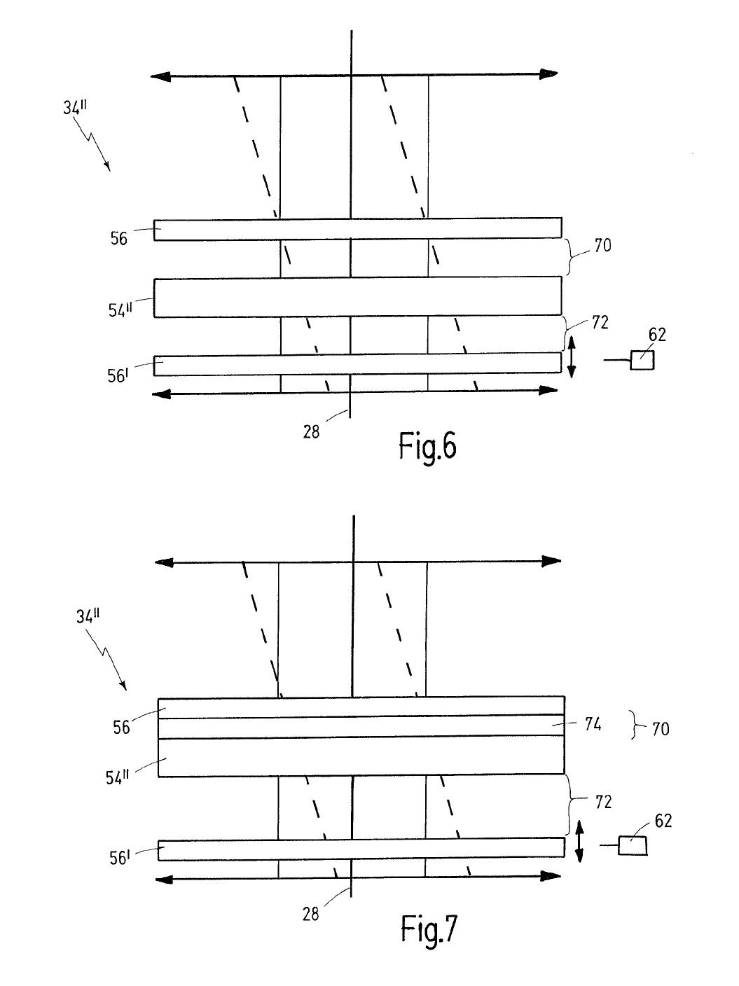

A simplification of the correction arrangement 34′ of FIG. 5 is shown in FIG. 6, in which a correction arrangement 34′ has only three correction elements 56, 56′ and 54″, the correction element 54″ constituting a combination of the correction elements 54 and 54′ in FIG. 5. The correction element 54″ has in this case an aspheric surface contour that is, for example, provided on one of its surfaces and which is complementary to the sum of the aspheric surface contours of the correction elements 56 and 56′, the surface contours of the correction elements 56 and 56′ optionally being identical and having the same sign.

In the zero position of the correction arrangement 34″, in which the latter does not develop optical corrective action, the correction element 54″ is arranged in the middle between the correction elements 56 and 56′. It is sufficient in this refinement that one of the correction elements 56 or 56′ is assigned a manipulator for displacing this correction element in the direction of the optical axis 28, the correction element 56′ being assigned the manipulator 62 in the exemplary embodiment shown. By displacing the correction element 56′ in the direction of the optical axis 28, the relative separation 70 between the correction element 56 and the correction element 54″ is varied in relation to the separation 72 between the correction element 54″ and the correction element 56′, the result being that it is possible to set the desired optical corrective action, specifically in both directions with reference to the zero position.

In a further simplification of the correction arrangement 34″, in accordance with the exemplary embodiment of FIG. 7 the correction arrangement 34″ is shown in a modification in which the correction element 56 is permanently connected to the correction element 54″ in a spaced apart arrangement specifically by interposing an optical element 74 that does not have an aspheric surface contour. In the case of this refinement, the separation 70 between the correction element 54″ and the correction element 56 is permanently set, and the separation 72 between the correction element 56′ and the correction element 54″ is varied appropriately in order to set a desired corrective action of the correction arrangement 34″. It goes without saying that the correction element 56, the correction element 54″ and the optical element 74 can be fabricated in one piece, the aspheric surface contour of the correction element 54″ being provided on the surface thereof facing the correction element 56′, and the aspheric surface contour of the correction element 56 being provided on the surface thereof averted from the correction element 54″.

Once again with reference to FIG. 1, the previously described concept of an optical correction arrangement is also suitable for the fact that in addition to the correction arrangement 34 installed in the projection objective 12 there are kept ready one or more further replacement correction arrangements 78 whose optical corrective action differ from the optical corrective action of the correction arrangement 34 or 34′ or 34″ in that the replacement correction arrangement 78 has at least two replacement correction elements 80, 82 whose aspheric surface contours differ from the aspheric surface contours of the correction elements 54, 56. If, for example, another aberration is detected during operation of the projection objective 12, instead of the correction arrangement 34 the replacement correction arrangement 78 is installed in the projection objective 12, and the replacement correction elements 80 and 82 of the replacement correction arrangement 78 are displaced in the direction of the optical axis 28 in order to compensate this detected aberration.

It can, moreover, be provided that in addition to the correction arrangement 34 there is permanently provided in the projection objective 12 a further correction arrangement 86 with a manipulator 88 whose optical corrective action differs from the optical corrective action of the correction arrangement 34, particularly when the correction arrangement 86 is arranged in a further pupil plane of the projection objective 12. The further optical correction arrangement can, however, also be arranged in or in the vicinity of a field plane, in order to correct a field-constant aberration. In general, the correction elements can be arranged in mutually optically conjugate planes, for example, as previously mentioned, in two or more pupil planes.

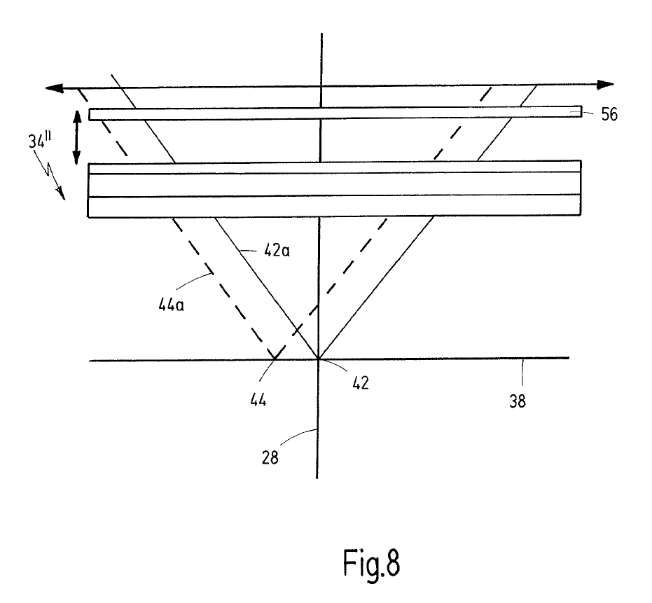

If, for example, the correction arrangement 34″ from FIG. 7 were arranged in the vicinity of the field plane 38 (compare FIG. 2), as is illustrated in FIG. 8, such that the correction arrangement is arranged in the convergent and divergent beam path of the light beams 42a and 44a, respectively, it is possible to compensate a field-constant component of an aberration by moving the optical element 56 for example, in order to correct a field offset, for example.

What is claimed is:

1. A method, comprising:
providing an optical system that comprises at least one optical correction arrangement comprising a plurality of optical correction elements which, at least locally, define an optical axis and which are provided with aspheric surface contours which add together overall at least approximately to zero, the at least one correction arrangement being in the vicinity of a pupil plane of the optical system; and
displacing at least one of the correction elements relative to at least one of the other optical correction elements at least with a directional component in a direction of the optical axis to set a desired corrective action of the correction arrangement,
wherein the optical system is configured to be used as a projection objective in microlithography.

2. The method of claim 1, wherein the at least one correction arrangement comprises two correction elements whose respective surface contours are provided on the mutually facing surfaces of the two correction elements.

3. The method of claim 2, wherein the two correction elements are immediately adjacent to each other.

4. The method of claim 1, wherein the at least one correction arrangement comprises two correction elements whose respective surface contours are provided on the mutually opposite surfaces of the two correction elements.

5. The method of claim 1, wherein the at least one correction arrangement comprises four correction elements of which two respectively have an identical first surface contour, and the other two respectively have an identical second surface contour which is complementary to the first surface contour, the two correction elements with the second surface contour being arranged between the two correction elements with the first surface contour.

6. The method of claim 5, wherein at least one of the correction elements is displaced.

7. The method of claim 1, wherein:
the at least one correction arrangement comprises three correction elements of which two respectively have an identical first surface contour;
the third has a second surface contour which is at least approximately complementary to the sum of the first surface contour of the two other correction elements;
the third correction element is arranged between the two correction elements with the first surface contour; and
at least one of the correction elements with the first surface contour is displaced.

8. The method of claim 1, wherein at least one of the surface contours is proportional to the function ∫Zₙ(x,y), Zₙ(x,y) being an nth order Zernike coefficient.

9. The method of claim 1, wherein the at least one correction element is displaced from a first position, in which the optical actions of the individual surface contours cancel out one another, into a second position, in which the desired correction action is achieved.

10. The method of claim 1, wherein for the at least one correction arrangement there is a replacement correction arrangement comprising a plurality of replacement correction elements which are provided with aspheric surface contours which add together overall at least approximately to zero, but which differ individually from the surface contours of the at least one correction arrangement, and wherein the at least one correction arrangement is replaced by the replacement correction arrangement in order to set a desired corrective action of the replacement correction arrangement by displacing at least one of the replacement correction elements relative to at least one of the remaining optical replacement correction elements at least with a directional component in the direction of the optical axis.

11. The method of claim 1, wherein the optical system comprises at least one second correction arrangement which has a plurality of second optical correction elements which, at least locally, define an optical axis and are provided with aspheric surface contours which add together overall at least approximately to zero but which differ individually from the surface contours of the at least one correction arrangement, and wherein at least one of the second correction elements is displaced relative to at least one of the remaining second correction elements at least with a directional component in the direction of the optical axis, in order to set a desired corrective action of the second correction arrangement.

12. The method of claim 1, wherein at least one of the correction elements is additionally or exclusively displaced with a directional component in a direction transverse to the optical axis.

13. The method of claim 1, further comprising at least one further correction arrangement arranged at least in the vicinity of a field plane, wherein at least one correction element of the further correction arrangement is displaced at least with a directional component in the direction of the optical axis.

14. An optical system, comprising:
at least one optical correction arrangement that comprises a plurality of optical correction elements which, at least locally, define an optical axis and which are provided with aspheric surface contours which add together overall at least approximately to zero, at least one of the correction elements being assigned at least one manipulator to be capable of displacing the correction element relative to at least one of the remaining correction elements at least with a directional component in the direction of the optical axis,
wherein the at least one correction arrangement is arranged at least in the vicinity of a pupil plane of the optical system, and the optical system is a projection objective configured to be used in microlithography.

15. The optical system of claim 14, wherein the at least one correction arrangement comprises two correction elements whose respective surface contours are provided on the mutually facing surfaces of the two correction elements.

16. The optical system of claim 15, wherein the two correction elements are immediately adjacent to each other.

17. The optical system of claim 14, wherein the at least one correction arrangement comprises two correction elements whose respective surface contours are provided on the mutually opposite surfaces of the two correction elements.

18. The optical system of claim 14, wherein the at least one correction arrangement comprises four correction elements of which two respectively have an identical first surface contour, and the other two respectively have an identical second surface contour which is complementary to the first surface contour, and wherein the two correction elements with the second surface contour are arranged between the two correction elements with the first surface contour.

19. The optical system of claim 18, wherein the at least one manipulator is assigned to at least one of the outer correction elements.

20. The optical system of claim 18, wherein the at least one manipulator is assigned to at least one of the inner correction elements.

21. The optical system of claim 14, wherein:
the at least one correction arrangement comprises three correction elements of which two respectively have an identical first surface contour;
the third has a second surface contour which is at least approximately complementary to the sum of the first surface contour of the two other correction elements; and
the third correction element is between the two correction elements with the first surface contour.

22. The optical system of claim 21, wherein one of the correction elements with the first surface contour is connected to the intermediate third correction element in a fashion spaced apart therefrom.

23. The optical system of claim 21, wherein at least one of the correction elements with the first surface contour is assigned the at least one manipulator.

24. The optical system of claim 14, wherein at least one of the surface contours is proportional to the function ∫Zₙ(x,y), Zₙ(x,y) being an nth order Zernike coefficient.

25. The optical system of claim 14, wherein for the at least one correction arrangement there is a replacement correction arrangement comprising a plurality of replacement correction elements which are provided with aspheric surface contours which add together overall at least approximately to zero, but which differ individually from the surface contours of the at least one correction arrangement, and wherein the at least one correction arrangement can be replaced by the replacement correction arrangement.

26. The optical system of claim 14, further comprising a second correction arrangement comprising a plurality of second optical correction elements which, at least locally, define an optical axis and are provided with aspheric surface contours which add together overall at least approximately to zero but which differ individually from the surface contours of the at least one correction arrangement, and wherein the at least one of the second correction elements is assigned at least one second manipulator configured to displace this correction element relative to at least one of the remaining second correction elements at least with a directional component in the direction of the optical axis.

27. The optical system of claim 14, wherein at least one of the correction elements is assigned a manipulator configured to displace the correction element additionally or exclusively with a directional component in a direction transverse to the optical axis.

28. The optical system of claim 14, further comprising at least one further correction arrangement at least in the vicinity of a field plane, and in that at least one correction element of this further correction arrangement is assigned at least one manipulator configured to displace the correction element at least with a directional component in the direction of the optical axis.

29. The optical system of claim 14, wherein the correction elements are arranged in mutually optically conjugate planes of the optical system.

30. An optical system comprising:
a plurality of optical elements, at least two of the plurality of optical elements having complementary surface contours,
wherein:
the at least two of the plurality of optical elements are configured so that, during use of the optical system, the at least two of the plurality of optical elements correct imaging errors having a Zernike order higher than 5 present at an image plane of the optical system; and
the optical system is configured to be used in microlithography.

31. The optical system of claim 30, wherein the optical system is a projection objective.

32. The optical system of claim 30, wherein the complementary surface contours are aspheric.
